(19) United States
(12) Patent Application Publication
(10) Pub. No.: US 2002/0068582 A1
(43) Pub. Date: Jun. 6, 2002

(54) Method, system and mediation device for reporting information to a Law Enforcement Agency

(75) Inventor: Ella Zawislak, Montreal (CA)

Correspondence Address: ANDRE M. SZUWALSKI, Jenkens & Gilchrist, P.C., 1445 Ross Avenue, Dallas, TX, 75202-2799, US

(73) Assignee: Telefonaktiebolaget L M Ericsson

(21) Appl. No.: 09/726,352

(22) Filed: Dec. 1, 2000

(51) Int. Cl. H04Q 7/20

(52) U.S. Cl. 455/456; 455/404; 455/521

(57) ABSTRACT

In a cellular telecommunications network, a method, system and corresponding Mediation Device (MD) for interfacing an Intercept Functionality (IF) of a cellular telecommunications network with at least a Law Enforcement Agency (LEA) monitoring an intercept subject. The MD comprises a mapping table for associating an LEA case identity for identifying the intercept subject in the LEA with a local case identity used in communications between the MD and the IF. The LEA requests the monitoring of the intercept subject by sending a monitoring request having the LEA case identity to the MD, which assigns a local case identity for designating the intercept subject and relays the monitoring request, having the local case identity, to the IF. Upon receipt of the monitoring request, the IF sets-up the monitoring of the intercept subject. When the desired monitored information is detected by an Access Function (AF) of the IF, it is relayed by the Delivery Function (DF) of the IF to the MD in the form of a message also comprising the local case identity. The MD receives the message, extracts the local case identity, and maps it to the LEA case identity, and to LEA routing information associated therewith, and transmits a second message having the same monitored information, using at least one of the LEA case identity and the LEA routing information.

### BACKGROUND OF THE INVENTION

1. Field of the Invention

The present invention relates to the monitoring of cellular telecommunications network subscribers communications, and particularly to a method, a system, and a Mediation Device (MD) for reporting monitored information to a Law Enforcement Agency (LEA).

2. Description of the Related Art

When Law Enforcement Agencies (LEAs) are authorized to monitor cellular phone calls to obtain evidence for use in criminal investigations, the most important pieces of information they obtain (the monitored information) is the recorded voice conversation itself, the identification of the parties participating in the call, and the location of these parties. The monitored information is extracted from the cellular telecommunications network using various triggers by an Access Function (AF) comprising one or more Intercept Access Points (IAPs) implemented in the cellular telecommunications network itself. For example, the IAPs may be a functionality connected to a Mobile Switching Center (MSC) or a Home Location Register (HLR) of the monitored cellular telecommunications network. The AF further communicates and sends the intercepted monitored information related to an intercept subject (the monitored subscriber) to a Delivery Function (DF) which is typically also implemented in the cellular telecommunications network and which function is to route the monitored information toward the appropriate LEA(s). The monitoring-related entities within the cellular telecommunications network, such as the AF having one or more IAPs and the DF are designated hereinafter as the Intercept Functionality (IF). Thus, the LEA(s) receive(s) the monitored information sent from the IF in a Collection Function (CF) that may format the information in layouts which are easy to understand by LEA's agents.

In many implementations, the intercept subject is identified by a case identification code (CaseId) in both the LEA and the telecommunications network. Therefore, assuming a scenario wherein the DF of the IF communicates directly with the LEA's CF, such as for example when the IF is to inform the LEA of a location update of the intercept subject (i.e. for example when the intercept subject moves from a first service area to a second service area), the IF sends to the LEA a ServingSystem message comprising parameters such as the CaseId for identifying the intercept subject itself, a location information for identifying the location where the intercept subject has moved to, and a TimeStamp parameter for informing of the time when the subscriber's move occurred.

In other implementations, the intercept subject may still be identified by a CaseId, but the IF may be interfaced with the LEAs by a Mediation Device (MD). However, in such configurations, when one MD is connected to a plurality of LEAs, some conflicts between similar CaseId parameters identifying different intercept subjects in different LEAs may occur, and the monitored information may be routed to the wrong LEA. For example, if the IF of a given cellular telecommunications network is connected to one MD, which is further connected to two LEAs, in some situations, then each LEA may request the monitoring of a different intercept subject, but at the same time may both identify the two different intercept subjects using identical CaseIds. This situation may occur especially when different sections (herein encompassed by the designation “LEAs”) from the same police department (e.g. New York Police Department, NYPD) designate different intercept subjects using the same CaseId. For example, a first LEA may request the monitoring of subscriber “John Doe” designated by Case Id “NYPD008” by the first LEA of the NYPD, and receiving cellular service from service provider “X”, while a second LEA from the NYPD may request, essentially during the same period of time, the monitoring of subscriber “Greg Fourniquet” designated by a similar CaseId “NYPD008” by the second LEA of the NYPD, and receiving cellular service from the same service provider “X”. In such instances, the MD receives the monitoring requests from the LEAs and further requests from the IF the monitoring of the two subscribers. When accessed, the monitored information of one of the monitored subscribers is sent from the DF of the IF to the MD. However, upon receipt of the monitored information, since the MD has two identical CaseIds, a confusion between the two monitored subscribers may occur, and the MD may send the monitored information to the wrong LEA.

It would be advantageous to have a method, system, and mediation device that could avoid such confusions and accurately relay the monitored information to the appropriate LEA. In particular, there is an advantage to have a method, system, and mediation device for reliably monitoring intercept subjects in the cellular telecommunications network, even in instances wherein similar or identical CaseIds are assigned to different monitored subjects by different LEAs.

The present invention provides such solutions.

### SUMMARY OF THE INVENTION

It is therefore an object of the present invention to provide a method for monitoring a subscriber in a cellular telecommunications network, the method comprising the steps of sending a first monitoring request from a Law Enforcement Agency (LEA) to a Mediation Device (MD), the request comprising an LEA case identity parameter for identifying a subscriber to be monitored in the cellular telecommunications network; responsive to a receipt of the first monitoring request in the MD, allocating a local case identity for identifying the monitored subscriber, the local case identity being mapped to the LEA case identity for designating the same subscriber; and sending from the MD to an Intercept Functionality (IF) of the cellular telecommunications network a second monitoring request comprising the local case identity for identifying the subscriber to be monitored within the cellular telecommunications network.

It is another object of the present invention to provide a method for monitoring a cellular subscriber of a cellular telecommunications network, the method comprising the steps of sending from an Intercept Functionality (IF) to a Mediation Device (MD) a first message, the message comprising monitored information regarding a monitored subscriber and a local case identity for identifying the monitored subscriber; responsive to a receipt of the first message in the MD, mapping the local case identity to a Law Enforcement Agency (LEA) case identity identifying the monitored subscriber within the LEA; and sending a second message from the MD to the LEA using the LEA case identity parameter, the second message comprising the monitored information.

It is yet another object of the invention to provide a Mediation Device (MD) for interfacing an Intercept Functionality (IF) of a cellular telecommunications network with at least one Law Enforcement Agency (LEA), the MD comprising a mapping table for storing at least an LEA case identity parameter and a local case identity parameter, wherein the LEA case identity parameter identifies a monitored subscriber in the LEA while the local case identity parameter identifies the same monitored subscriber in communications from the IF to the MD.

It is yet another object of the invention to provide a cellular telecommunications network monitoring system comprising i) an Intercept Functionality (IF) for accessing monitored information regarding a monitored subscriber of a cellular telecommunications network; ii) at least one Law Enforcement Agency (LEA) receiving the monitored information regarding the monitored subscriber; and iii) a Mediation Device (MD) connected to, and receiving from the IF a first message comprising monitored information regarding the monitored subscriber, the first message comprising a local case identity for designating the monitored subscriber, wherein responsive to a receipt of the first message in the MD, the MD maps the local case identity to a Law Enforcement Agency (LEA) case identity that identifies the monitored subscriber within the LEA, and sends a second message comprising the monitored information to the LEA using the LEA case identity.

### BRIEF DESCRIPTION OF THE DRAWINGS

For a more detailed understanding of the invention, for further objects and advantages thereof, reference can now be made to the following description, taken in conjunction with the accompanying drawings, in which:

FIG. 1.a (Prior Art) is a top level block diagram of an exemplary cellular telecommunications network monitoring system according to a typical prior art implementation;

FIG. 1.b (Prior Art) is a top level block diagram of another exemplary cellular telecommunications network monitoring system according to another typical prior art implementation;

FIG. 2.a is a nodal operation and signal flow diagram illustrative of an exemplary preferred embodiment of the invention; and

FIG. 2.b is an exemplary high-level block diagram representative of a Mediation Device (MD) according to a preferred embodiment of the present invention.

### DETAILED DESCRIPTION OF THE PREFERRED EMBODIMENTS

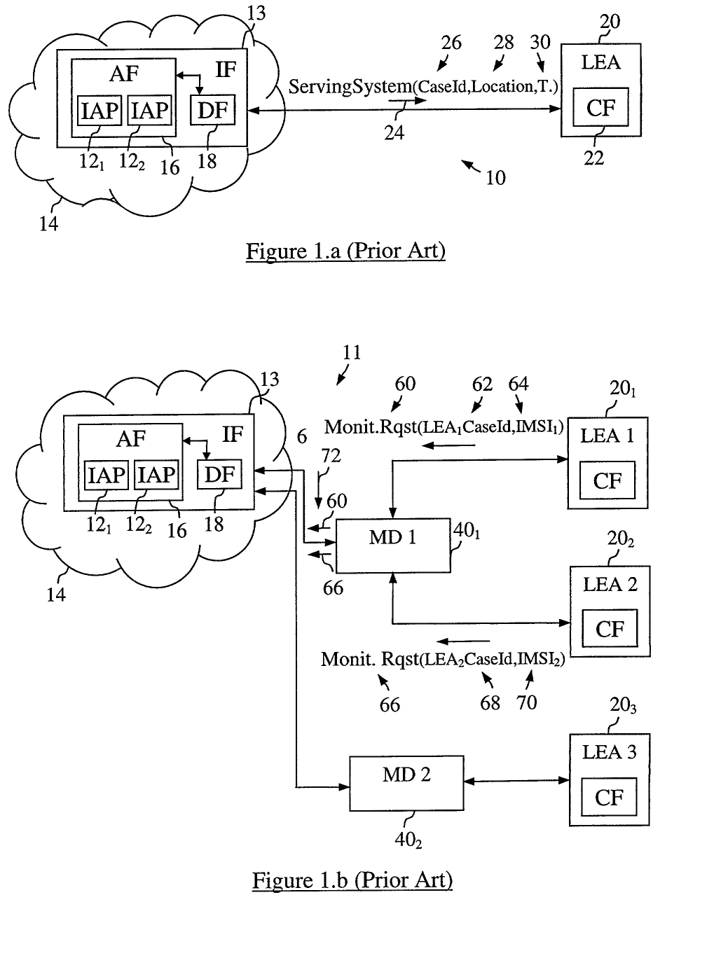

Reference is now made to FIG. 1.a (Prior Art) wherein there is shown a top level block diagram of an exemplary cellular telecommunications network monitoring system 10 according to a typical prior art implementation. The cellular telecommunications network monitoring system 10 may comprise an Intercept Functionality 13 located in the monitored cellular telecommunications network 14 and comprising an Access Function (AF) 16 for detecting and accessing the monitored information through, for example, two Intercept Access Points (IAPs) 12₁ and 12₂, typically connected to a Mobile Switching Center or a Home Location Register, (not shown). The IF 13 further comprises a Delivery Function (DF) 18 for delivering the monitored information from the cellular telecommunications network 14 to at least one Law Enforcement Agency (LEA) 20. The LEA 20 receives the monitored information in a Collection Function (CF) 22 that may reformat the received monitored information in order to make it easily readable for LEA agents. The specifications and communications protocols for the AF 16, the DF 18, and the CF 22 may be the ones specified in the standard TIA/EIA/J-STD-025A Lawfully Authorized Electronic Surveillance, herein enclosed by reference.

For example, when the intercept subject (the monitored subscriber) performs a service area update, i.e. when the monitored subscriber moves from a first service area to a second service area of the cellular telecommunications network 14, the AF 16 of the IF 13 issues a ServingSystem message 24 for informing the LEA 20 of the subscriber's location update. Typically, the ServingSystem message 24 comprises a CaseId parameter 26 for identifying the monitored subscriber who changed locations, one or more location information parameter(s) 28 for identifying the new location of the intercept subject, and a TimeStamp parameter 30 for identifying the time when the update occurred. The CF 22 of the LEA 20 receives the ServingSystem message 24 and is thus informed of the new location of the intercept subject.

Reference is now made to FIG. 1.b, wherein there is shown a top level block diagram of another exemplary cellular telecommunications network monitoring system 11 according to another typical prior art implementation. In FIG. 1.b, the IF 13 is interfaced with a number of LEAs 20₁-20₃ through two MDs 40₁ and 40₂. MD 40₁ connects the IF 13 located in the cellular telecommunications network 14 to the LEA 20₁ and to the LEA 20₂, while the MD 40₂ connects the same IF 13 to the LEA 20_{3.}

When the LEAs initially request the monitoring of intercept subjects, they typically send through the connected MD 40ᵢ to the IF 13 the identification of the subject to be monitored. Such identification may comprise or consist of the CaseId parameter assigned by each LEA to the monitored subject, and possibly by the International Mobile Station Identification (IMSI). For example, with reference being made to FIG. 1.b, the LEA₁ 20₁ may request the monitoring of subscriber “John Doe”, and for that purpose may send a monitoring request 60 to the MD 40₁, the monitoring request 60 comprising the LEA₁ CaseId 62 that identifies the intercept subject “John Doe” for the LEA₁ 20₁, and the IMSI₁ 64 identifying the intercept subject “John Doe” in the cellular telecommunications network 14. The MD 40₁ relays the monitoring request 60 to IF 13, which upon receipt of the request sets-up in the AF 16 the interception criteria necessary for actually monitoring the communications of the intercept subject.

Substantially at the same time, the LEA₂ 20₂ may request the monitoring of another subscriber, such as for example of subscriber “Greg Fourniquet”, and for that purpose sends a monitoring request 66 to the same MD 40₁, the monitoring request 66 comprising a CaseId 68 that identifies the intercept subject “Greg Fourniquet” for the LEA₂ 20₂, and the IMSI₂ 70 identifying the subscriber “Greg Fourniquet” in the cellular telecommunications network 14. The MD 40₁ relays the monitoring request 66 to the IF 13, which upon receipt of the request sets-up in the AF 16 the interception criteria necessary for actually monitoring the communications of the intercept subject. It was observed that in some instances, the CaseId parameters sent from different LEAs for identifying different intercept subjects, such as for example in the present example from LEA₁ 20₁ and from LEA₂ 20₂ for identifying subscribers “John Doe” and “Greg Fourniquet” respectively, can be identical and thus create confusions when returning the monitored information from the IF 13 to the LEAs. This is due to the fact that according to the existing standard, the messages sent from the IF 13 and comprising the monitored information, such as for example the ServingSystem message, utilize the CaseId parameter for routing the monitored information toward the LEAs. Therefore, when duplicate CaseId parameters exist, and for example, when monitored information is to be sent regarding a first subscriber, such as subscriber “John Doe” monitored by the LEA₁ 20₁, errors may occur. For example, when a ServingSystem update is to be performed for a monitored subscriber monitored by LEA 1 20₁, the IF 13 sends a ServingSystem message 72 to the MD 40₁, the message 72 comprising an CaseId parameter identifying subscriber “John Doe”, at least one location parameter for identifying the actual location of the intercept subject, and a TimeStamp parameter stating the time when the location update is performed. The MD 40₁ receives the message 72, and since it has two identical CaseId parameters that identify two different intercept subjects, i.e. subscriber “John Doe” and subscriber “Greg Fourniquet”, it may forward the monitored information received in message 72 to the wrong destination, i.e. to LEA 20₂, or not forward the monitored information at all.

It would be advantageous to have a method, system, and mediation device that could avoid such confusions and accurately relay the monitored information to the appropriate LEA. In particular, there is an advantage to have a method, system, and mediation device for reliably monitoring intercept subjects of the cellular telecommunications network 14 and accurately relaying the monitored information to LEAs, even in instances wherein similar or identical CaseIds are assigned to different monitored subjects by different LEAs. The present invention provides such a solution.

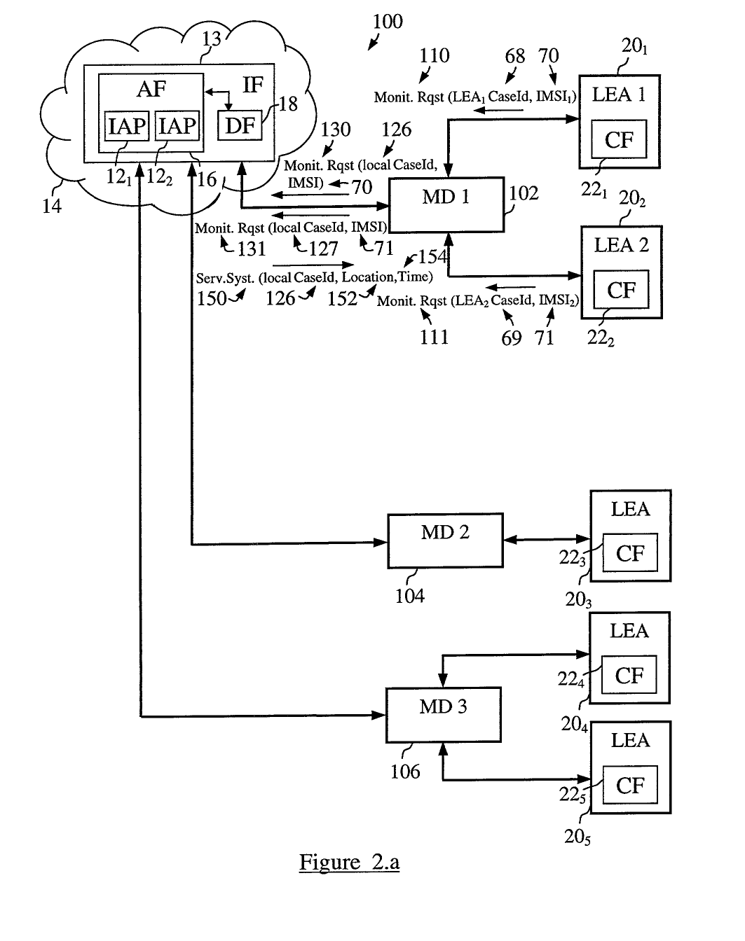

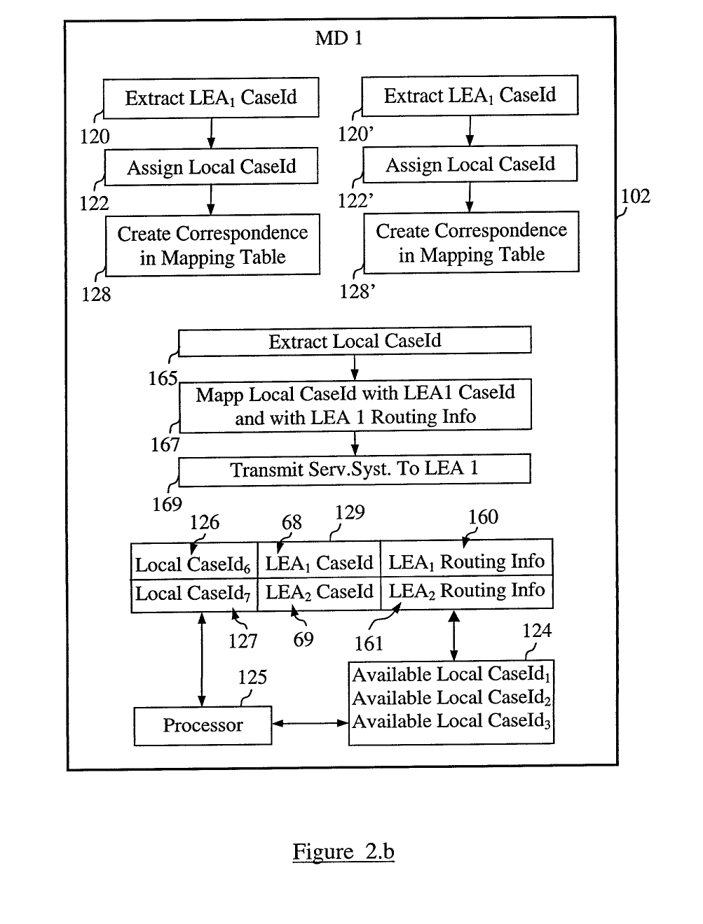

Reference is now made to FIG. 2.a, wherein there is shown a cellular telecommunications network monitoring system 100, comprising an Intercept Functionality (IF) 13 having an Access Function (AF) 16 comprising for example two Intercept Access Points (IAPs) 12₁ and 12₂, and a Delivery Function (DF) 18 as described hereinbefore. A first Law Enforcement Agency (LEA 1) 20₁ and a second LEA 2 20₂ are connected through a Mediation Device (MD) 102 to the IF 13. Other LEAs 20₃-20₅ may further be connected to the same IF 13 through other MDs 104-106 as shown. According to a preferred embodiment of the present invention, there are provided two classes of CaseIds: a first class comprising local CaseIds is used for identifying the intercept subjects by the MD 102 in communications with the cellular telecommunications network 14, and by the IF 13 of the cellular telecommunications network, while a second class of CaseIds comprising the LEAs— CaseIds is used for identifying the intercept subjects by the LEAs. The term “local” CaseIds is to be understood as designating the CaseId for the monitored network's side, by opposition to the LEAs' side, and is therefore to be utilized as mentioned, for identifying the intercept subjects by the MD 102 in communications with the cellular telecommunications network 14, and by the IF 13 of the cellular telecommunications network.

The invention can be better illustrated and understood by way of an exemplary scenario, somehow analogous to the one described hereinbefore, but wherein the system makes use of classes of CaseIds for monitoring an intercept subject and for accurately relaying the monitored information to the appropriate LEA according to the preferred embodiment of the invention.

With reference now being made jointly to FIG. 2.a and to FIG. 2.b, the LEA 1 20₁ may request the monitoring of subscriber “John Doe” in the cellular telecommunications network 14, by sending a monitoring request 110 to the MD 1 102, the monitoring request 110 comprising the LEA₁ CaseId 68 that identifies the intercept subject “John Doe” for the LEA 1 20₁, and the IMSI₁ 70 that identifies the subscriber “John Doe” in the cellular telecommunications network 14.

FIG. 2.b is an exemplary high-level block diagram representative of the MD 1 102 according to a preferred embodiment of the present invention. Responsive to the receipt of the monitoring request 110, the MD 102 may first extract the LEA 1 CaseId 68 from the message 110, action 120, and may then create, or assign a local CaseId for identifying the intercept subject in the cellular telecommunications network side, i.e. in communications with the network 14, and in the IF 13, action 122. According to the invention, action 122 may comprise, responsive to the receipt of the monitoring request 110, having a processor 125 of the MD 1 102 to extract the LEA 1 CaseId 68 from the message 110, and to assign, from a pool of available local CaseIds 124 a local CaseId 126 for identifying the intercept subject. Thus, a correspondence or a mapping may be established in a mapping table 129 of the MD 102 between the LEA₁ CaseId 68 and the local CaseId 126, which both identify the same intercept subject, wherein the LEA₁ CaseId 68 may be further associated with LEA₁ Routing Information that may be used for transmitting the monitored information from the MD 1 102 to the LEA1₁, in a manner that is yet to be described. After the creation of the establishment of the correspondence, action 128, the MD 102 transmits to the IF 13 a monitoring request 130 which is analogous to the monitoring request 110, but comprises the local CaseId 126 for identifying the intercept subject “John Doe”, and the IMSI₁ 70. Responsive to the receipt of request 130, the AF 16 of the IF 13 sets up the necessary triggers in the appropriate IAP(s) 12ᵢ for the actual monitoring of the intercept subject.

Substantially at the same time, i.e. after the transmission of the monitoring request 110 from LEA 1 20₁ and before the end of the monitoring of subscriber “John Doe”, another LEA, such as for example the LEA 2 20₂ may also request the monitoring of a subscriber, such as for example of subscriber “Greg Fourniquet” in the cellular telecommunications network 14, by sending a monitoring request 111 to the MD 102, the monitoring request 111 comprising the LEA₂ CaseId 69 that identifies the intercept subject “Greg Fourniquet” for the LEA 2 20₂, and the IMSI₂ 71 that identifies the subscriber “Greg Fourniquet” in the cellular telecommunications network 14. For the purpose of better describing the invention, it is assumed that LEA 1 is not aware of the actions of LEA 2, and vice-versa, and that by coincidence, the CaseId 68 sent by the LEA 1 in the monitoring request 110 is identical to the CaseId 69 sent by the LEA 2 in request 111, although they represent different intercept subjects (i.e. one represents “John Doe” while the other represents “Greg Fourniquet”). Responsive to the receipt of the monitoring request 111, the MD 102 first extracts the LEA₂ CaseId 69 from the message 111, action 120′ of FIG. 2.b, and then creates, or assigns a new local CaseId for identifying the intercept subject “Greg Fourniquet” in the cellular telecommunications network side, i.e. in communications with the network 14, and in the IF 13, action 122′. According to the invention, the MD 102, responsive to the receipt of the monitoring request 111, extracts the LEA₂ CaseId 69 from the message 111, and assigns, from the same pool of available local CaseIds 124 a local CaseId 127 for identifying the intercept subject. Thus, a new correspondence or a mapping is established in the mapping table 129 of the MD 102, this time between the LEA₂ CaseId 69 and the local CaseId 127, which both identify the same intercept subject. Following the creation of the establishment of the correspondence, action 128′, which is saved in a new record of the mapping table 129, the MD 102 transmits to the IF 13 a monitoring request 131, as shown in FIG. 2.a, which is analogous to the monitoring request 111, but comprises the local CaseId 127 for identifying the intercept subject “Greg Fourniquet”, and the IMSI₂ 71. Responsive to the receipt of the request 131, the AF 16 of the IF 13 sets up the necessary triggers in the IAPs 12ᵢ for the actual monitoring of the intercept subject “Greg Fourniquet”.

Therefore, according to a preferred embodiment of the present invention, the potential confusion that arose in the prior art technique described hereinbefore with respect to the Prior Art in cases of similar CaseIds being assigned to different subscribers is eliminated, since every time a monitoring request 110, 111 is received at the MD 102, according to the invention, the MD 102 assigns the new identifier (Local CaseIds 126, 127) from the pool 124 of available and unassigned Local CaseIds for identifying the intercept subjects in communications with the network 14's side.

Once the monitoring of both subscribers “John Doe” and “Greg Fourniquet” is set up in the IF 13 as described hereinbefore, at one point, the monitored information is accessed by the IAP(s) 12ᵢ, and must be sent to the appropriate LEA. In the present example, it is assumed that monitored information must be sent to LEA 1 20₁, regarding subscriber “John Doe” monitored by the LEA 1 20₁. For example, when subscriber “John Doe” moves from a first serving area to a second service area, a ServingSystem message must be sent for informing the LEA 1 that the intercept subject has changed locations.

According to the current standard TIA/EIA/J-STD-025A governing communications from the DF 18 to the CFs 22ᵢ of the LEAs, various messages comprising the monitored information that are sent from the DF toward the CF only use the CaseId parameter for identifying the intercept subject they relate to. For example, a ServingSystem message that informs the LEA of a location update of the intercept subject comprises, according to the current standard, the following parameters:

CaseId for identifying the intercept subject;

TimeStamp parameter for identifying the time when the location update occurred;

Location information for identifying the new location of the intercept subject, such as the SystemIdentity parameter for identifying the new serving system after the subscriber's move;

Although the current standard only support the above-mentioned parameters, other standards may further use other parameters for reporting the location information of an intercept subject, such as for example the IAPSystemIdentity for identifying the IAP 12ᵢ that intercepted the monitored information, and the NetworkAddress parameter for identifying the serving base station;

Therefore, when monitored information such as a location update is to be reported to the LEA 1 20₁, the DF 18 of the IF 13 sends a ServingSystem update message 150 to the MD 102, the message 150 comprising the local CaseId 126 identifying subscriber “John Doe” on the network 14's side, location information 152 for identifying the location where the intercept subject “John Doe” has moved to, and a TimeStamp parameter 154 stating the time when the move is performed. The location information 152 may comprise one or more of the location parameters enumerated hereinbefore. The MD 102 receives the message 150, and its processor 125 first extracts the local CaseId 126 from the message 150, action 165, and then maps the local CaseId 126 to the LEA 1 CaseId 68, action 167, by consulting the mapping table 129. Action 167 may further comprise mapping the local CaseId 126, or the corresponding LEA 1 CaseId 68, to the routing information 160 associated with the LEA 1 20₁. Thus, following action 167, the MD 102 knows the routing information related to the LEA 1 20₁, and relays a ServingSystem message 151 to the LEA 1 20₁, which is analogue to the message 150 but comprises the LEA₁ CaseId 68 instead of the local CaseId 126, action 169. Therefore, by using the mapping table 129 which establishes a clear correspondence between the LEAs' CaseIds and the local CaseIds (and implicitly with the routing information of the LEA) according to the preferred embodiment of the invention, the transmission of monitored information to the wrong LEAs observed in the prior art when the intercept subject was identified by the CaseId parameter in communications from the DF toward the CF, is completely eliminated.

Although the functions of the present invention were illustrated and described in relation to only two subscribers being monitored by two different LEAs, it is understood that many subscribers may be monitored by same or different LEAs using the present invention by applying the same described concept of assigning a new and different local CaseId to each intercept subject of each LEA, and by using the local CaseId parameter in communications from the DF to the MD.

According to a preferred embodiment of the present invention, the pool of available local CaseIds and the mapping table 129 of the MD 102 may be implemented using any type of memory-like devices or functionality, such as for example but not limited to a computer-operated database, an electronic programmable chip, a hardware device, or others. Preferably, the pool 124 may be a database having a field for the local CaseIds, and a plurality of records for holding the available local CaseIds, the database being run over the operating system of the MD 102. The mapping table 129 may be the same or an other database having at least two fields, one for the local CaseIds and one for the LEAs' CaseIds, but preferably three fields for also storing the routing information of the LEAs, and also having a plurality of records for holding the relation or correspondence between the local CaseIds and the LEA CaseIds. Furthermore, the method described in actions 120-122-128 may be implemented using one or more software modules, one or more hardware devices, or any combination thereof. Although several preferred embodiments of the method and system of the present invention have been illustrated in the accompanying Drawings and described in the foregoing Detailed Description, it will be understood that the invention is not limited to the embodiments disclosed, but is capable of numerous rearrangements, modifications and substitutions without departing from the spirit of the invention as set forth and defined by the following claims.

What is claimed is:

1. A method for monitoring a subscriber in a cellular telecommunications network, the method comprising the steps of:
sending a first monitoring request from a Law Enforcement Agency (LEA) to a Mediation Device (MD), the request comprising an LEA case identity parameter for identifying a subscriber to be monitored in the cellular telecommunications network;
responsive to a receipt of the first monitoring request in the MD, allocating a local case identity for identifying the monitored subscriber, the local case identity being mapped to the LEA case identity for designating the same subscriber; and
sending from the MD to an Intercept Functionality (IF) of the cellular telecommunications network a second monitoring request comprising the local case identity for identifying the subscriber to be monitored within the cellular telecommunications network.

2. The method claimed in claim 1, wherein the first and the second monitoring requests further comprise an International Mobile Subscriber Identification (IMSI) parameter for identifying the monitored subscriber.

3. The method claimed in claim 1, wherein the step of allocating comprises the steps of:
extracting the LEA case identity parameter from the first monitoring request;
assigning the local case identity for identifying the monitored subscriber, the local case identity being obtained from a pool of unassigned local case identity parameters; and
creating a correspondence between the LEA case identity and the local case identity, the correspondence being saved in a mapping table.

4. The method claimed in claim 1, wherein the IF comprises at least one Intercept Access Point (IAP) connected with at least one of a Mobile Switching Center (MSC) and a Home Location Register (HLR) for accessing the monitored information.

5. A method for monitoring a cellular subscriber of a cellular telecommunications network, the method comprising the steps of:
sending from an Intercept Functionality (IF) to a Mediation Device (MD) a first message, the message comprising monitored information regarding a monitored subscriber and a local case identity for identifying the monitored subscriber;
responsive to a receipt of the first message in the MD, mapping the local case identity to a Law Enforcement Agency (LEA) case identity identifying the monitored subscriber within the LEA; and
sending a second message from the MD to the LEA using the LEA case identity parameter, the second message comprising the monitored information.

6. The method claimed in claim 5, wherein the LEA case identity is associated with LEA routing information.

7. The method claimed in claim 5, wherein the first message comprises a Serving System message identifying a location where the monitored subscriber has moved to.

8. The method claimed in claim 5, wherein the step of sending a first message is performed by a Delivery Function (DF) of the IF.

9. The method claimed in claim 5, further comprising the step of:
receiving the second message in a Collection Function (CF) of the LEA.

10. The method claimed in claim 5, wherein the IF comprises at least one Intercept Access Point (IAP) connected with at least one of a Mobile Switching Center (MSC) and a Home Location Register (HLR) for accessing the monitored information.

11. The method claimed in claim 5, wherein the LEA case identity parameter is associated with LEA routing information for routing the second message to the LEA.

12. A Mediation Device (MD) for interfacing an Intercept Functionality (IF) of a cellular telecommunications network with at least one Law Enforcement Agency (LEA), the MD comprising:
a mapping table for storing at least an LEA case identity parameter and a local case identity parameter, wherein the LEA case identity parameter identifies a monitored subscriber in the LEA while the local case identity parameter identifies the same monitored subscriber in communications from the IF to the MD.

13. The MD claimed in claim 12, further comprising:
a pool of unassigned local case identities; and
a processor that responsive to a receipt of a monitoring request from an LEA, allocates a local case identity obtained from the pool of unassigned local case identities, and establishes a correspondence between the local case identity and the LEA case identity, the correspondence being saved in the mapping table.

14. The MD claimed in claim 13, wherein the MD
receives from the Intercept Functionality (IF) a first message comprising monitored information regarding a monitored subscriber and a local case identity for identifying the monitored subscriber;
responsive to a receipt of the first message and using the mapping table, maps the local case identity to a Law Enforcement Agency (LEA) case identity identifying the monitored subscriber within the LEA; and
sends a second message to the LEA using the LEA case identity parameter, the second message comprising the monitored information.

15. The MD claimed in claim 14, wherein the LEA case identity parameter is associated with an LEA routing information used by the MD to route the second message to the LEA.

16. The MD claimed in claim 14, wherein the first and second messages comprise a location update information regarding the monitored subscriber.

17. The MD claimed in claim 16 wherein the first and second messages comprise a ServingSystem message.

18. A cellular telecommunications network monitoring system comprising:
an Intercept Functionality (IF) for accessing monitored information regarding a monitored subscriber of a cellular telecommunications network;
at least one Law Enforcement Agency (LEA) receiving the monitored information regarding the monitored subscriber; and
a Mediation Device (MD) connected to, and receiving from the IF a first message comprising monitored information regarding the monitored subscriber, the first message comprising a local case identity for designating the monitored subscriber, wherein responsive to a receipt of the first message in the MD, the MD maps the local case identity to a Law Enforcement Agency (LEA) case identity that identifies the monitored subscriber within the LEA, and sends a second message comprising the monitored information to the LEA using the LEA case identity.

19. The cellular telecommunications network claimed in claim 18, wherein:
the IF comprises:
an Access Function (AF) for accessing the monitored information; and
a Delivery Function (DF) for delivering the monitored information to the MD; and
the LEA comprises a Collection Function (CF) for collecting the second message comprising the monitored information.

20. The cellular telecommunications network claimed in claim 18, wherein the first and the second messages comprise a Serving System message for reporting a location update of the monitored subscriber.

21. The cellular telecommunications network claimed in claim 18, wherein the MD comprises a mapping table for saving a correspondence between the local case identity and the LEA case identity.

22. The cellular telecommunications network claimed in claim 21, wherein the mapping table further comprises routing information for routing the second message to the LEA, the routing information being associated to the LEA case identity.
